(19) United States
(12) Patent Application Publication
(10) Pub. No.: US 2010/0132880 A1
(43) Pub. Date: Jun. 3, 2010

(54) COMPOSITE HONEYCOMB SANDWICH PANEL SPLICING

(76) Inventors: Kevin Patrick Kelleher, Kirkland, WA (US); Aaron Golden Coon, Marysville, WA (US)

Correspondence Address: DUKE W. YEE, YEE & ASSOCIATES, P.C., P.O. BOX 802333, DALLAS, TX, 75380, US

(21) Appl. No.: 12/325,460

(22) Filed: Dec. 1, 2008

(51) Int. Cl. B29C 65/48; B32B 37/00

(52) U.S. Cl. 156/245; 156/304.3; 156/391

(57) ABSTRACT

A method and apparatus for joining composite parts is present. A first composite part is aligned with a second composite part to form an aligned structure with a splice line. An adhesive layer may cover the splice line. A composite material is placed on the adhesive layer. The aligned structure is cured with the adhesive layer and the composite material to form a joined structure.

### BACKGROUND INFORMATION

1. Field

The present disclosure relates generally to manufacturing and, in particular, to a method and apparatus for joining parts to each other. Still more particularly, the present disclosure relates to a method and apparatus for joining composite parts to each other.

2. Background

Aircraft are being designed and manufactured with greater and greater percentages of composite materials. Some aircraft may have more than fifty percent of their primary structure made from composite materials. Composite materials may be used in aircraft to decrease the weight of the aircraft. This decreased weight may improve payload capacities and fuel efficiencies. Further, composite materials may provide longer service life for various components in an aircraft.

Composite materials may be strong, light-weight materials, created by combining two or more dissimilar components. For example, without limitation, a composite may include fibers and resins. The fibers and resins may be combined to form a cured composite material.

Composite materials such as, for example, without limitation, composite honeycomb sandwich panels may be used in the interior of an aircraft. These panels may be used for walls, floors, light covers, and other suitable structures for the interior of an aircraft. A composite sandwich panel may have a honeycomb core with a faceplate (face sheet) on either side of the honeycomb core. This faceplate may be, for example, without limitation, a laminate and/or other composite material.

In some cases, it may be desirable to join or attach composite parts to each other. For example, without limitation, with light shields, these types of panels may be made of a carbon fiber skin with a honeycomb core. The ends of these light shields may be rounded. These panels also may have different length requirements depending on the interior configuration of a passenger cabin.

Rather than purchasing and/or manufacturing a tool for each length, a tool with the longest length may be used to create a panel. This panel may then be cut into parts of the appropriate size. These parts may be joined to each other with a structural bond. This joining of parts may also be referred to as splicing. This process may involve the use of non-robust materials and may be tedious. As a result, increased out of tolerance and scrap rates may occur.

The current process may involve removing a portion of the honeycomb core out of each part to be joined to each other. The two parts may then be joined by applying a potting and/or adhesive material within the core. The parts may be clamped to each other for several hours. Thereafter, the parts may be sanded for the application of a decorative layer.

For example, the parts may be cured for around 24 hours to fully join the parts to each other. This type of process may have less than desirable out of tolerance rates during assembly and/or installation of these panels. The time needed to join the parts to each other also may slow down the speed at which an aircraft may be assembled as well as possibly increase assembly costs.

Therefore, it would be advantageous to have a method and apparatus that overcomes one or more of the issues discussed above.

### SUMMARY

In one advantageous embodiment, a method for joining composite parts may be present. A first composite part may be aligned with a second composite part to form an aligned structure with a splice line. An adhesive layer may cover the splice line. A composite material may be placed on the adhesive layer. The aligned structure may be cured with the adhesive layer and the composite material to form a joined structure.

In another advantageous embodiment, a method for manufacturing a composite honeycomb sandwich panel may be present. A first composite honeycomb sandwich panel may be aligned with a second composite honeycomb sandwich panel to form an aligned structure with a splice line. An epoxy film may be placed on the splice line. A fabric with an embedded resin may be placed on the epoxy film. The aligned structure may have a first side and a second side. The epoxy film and the fabric with the embedded resin may be placed on the first side and the second side. The fabric may be selected from one of a fiberglass fabric and a carbon fabric. The resin may be selected from one of a phenolic resin and an epoxy resin. The aligned structure with the epoxy film and the fabric with the embedded resin may be placed in a die. The die may cover the splice line. The aligned structure in the die may be heated under pressure to form a joined structure. A decorative layer may be applied on the joined structure. The completed structure may be selected from one of a composite panel, a wall panel, and a light shield.

In yet another advantageous embodiment, an apparatus may comprise a first composite part, a second composite part, an adhesive layer, a composite material, and a tool. The first composite part may be aligned with a second composite part to form an aligned structure with a splice line. The adhesive layer may cover the splice line. The composite material may be located on the adhesive layer. The tool may be capable of holding the aligned structure with the adhesive layer covering the splice line and the composite material located on the adhesive layer.

In still yet another advantageous embodiment, an apparatus for splicing honeycomb composite parts may comprise a first composite honeycomb sandwich panel, a second composite honeycomb sandwich panel, an epoxy film, a fabric, and a tool. The first composite honeycomb sandwich panel may be aligned with a second composite honeycomb sandwich panel to form an aligned structure with a splice line. The epoxy film may cover the splice line. The fabric with an embedded resin may be located on the epoxy film. The tool may be capable of holding the aligned structure with the epoxy film located on the splice line and the fabric with the embedded resin. The fabric may be selected from one of a fiberglass fabric and a carbon fabric. The resin may be selected from one of a phenolic resin and an epoxy resin. The joined structure may be selected from one of a composite panel, a wall panel, and a light shield.

The features, functions, and advantages may be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the advantageous embodiments are set forth in the appended claims. The advantageous embodiments, however, as well as a preferred mode of use, further objectives, and advantages thereof, will best be understood by reference to the following detailed description of an advantageous embodiment of the present disclosure when read in conjunction with the accompanying drawings, wherein:

FIG. 1 is a diagram illustrating an aircraft manufacturing and service method in accordance with an advantageous embodiment;

FIG. 2 is a diagram of an aircraft in which an advantageous embodiment may be implemented;

FIG. 3 is a diagram of a splicing environment in accordance with an advantageous embodiment;

FIG. 4 is a diagram of a cross-sectional view of an aligned structure in accordance with an advantageous embodiment;

FIG. 5 is a diagram of a cross-sectional view illustrating layers of materials for joining composite parts in accordance with an advantageous embodiment;

FIG. 6 is a diagram of a cross-sectional view illustrating a completed structure in accordance with an advantageous embodiment;

FIG. 7 is a diagram of a composite honeycomb panel in accordance with an advantageous embodiment;

FIG. 8 is a diagram illustrating application of an adhesive layer in accordance with an advantageous embodiment;

FIG. 9 is a diagram illustrating an application of a composite material to a structure in accordance with an advantageous embodiment;

FIG. 10 is a diagram illustrating application of a composite material to a structure in accordance with an advantageous embodiment;

FIG. 11 is a diagram illustrating an aligned structure on a tool in accordance with an advantageous embodiment;

FIG. 12 is a diagram illustrating a cured aligned structure in accordance with an advantageous embodiment;

FIG. 13 is a diagram of an aligned structure in accordance with an advantageous embodiment; and

FIG. 14 is a flowchart of a process for joining composite parts in accordance with an advantageous embodiment.

### DETAILED DESCRIPTION

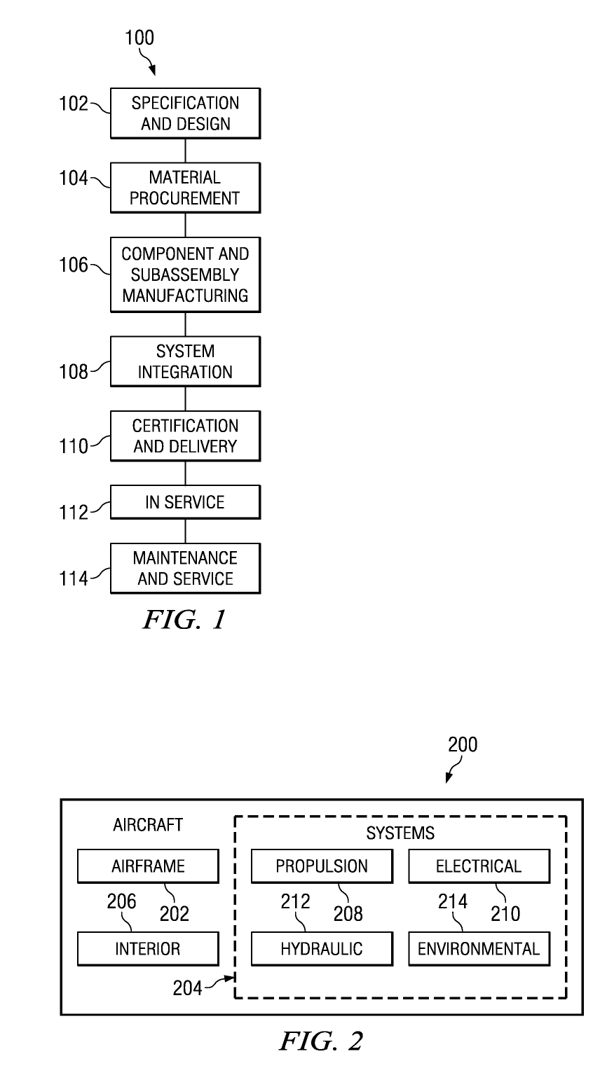

Referring more particularly to the drawings, embodiments of the disclosure may be described in the context of aircraft manufacturing and service method 100 as shown in FIG. 1 and aircraft 200 as shown in FIG. 2. Turning first to FIG. 1, a diagram illustrating an aircraft manufacturing and service method is depicted in accordance with an advantageous embodiment. During pre-production, exemplary aircraft manufacturing and service method 100 may include specification and design 102 of aircraft 200 in FIG. 2 and material procurement 104.

During production, component and subassembly manufacturing 106 and system integration 108 of aircraft 200 in FIG. 2 takes place. Thereafter, aircraft 200 in FIG. 2 may go through certification and delivery 110 in order to be placed in service 112. While in service by a customer, aircraft 200 in FIG. 2 is scheduled for routine maintenance and service 114, which may include modification, reconfiguration, refurbishment, and other maintenance or service.

Each of the processes of aircraft manufacturing and service method 100 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of venders, subcontractors, and suppliers; and an operator may be an airline, leasing company, military entity, service organization, and so on.

With reference now to FIG. 2, a diagram of an aircraft is depicted in which an advantageous embodiment may be implemented. In this example, aircraft 200 is produced by aircraft manufacturing and service method 100 in FIG. 1 and may include airframe 202 with a plurality of systems 204 and interior 206. Examples of systems 204 include one or more of propulsion system 208, electrical system 210, hydraulic system 212, and environmental system 214. Any number of other systems may be included. Although an aerospace example is shown, different advantageous embodiments may be applied to other industries, such as the automotive industry.

Apparatus and methods embodied herein may be employed during any one or more of the stages of aircraft manufacturing and service method 100 in FIG. 1. For example, components or subassemblies produced in component and subassembly manufacturing 106 in FIG. 1 may be fabricated or manufactured in a manner similar to components or subassemblies produced while aircraft 200 is in service 112 in FIG. 1.

Also, one or more apparatus embodiments, method embodiments, or a combination thereof may be utilized during production stages, such as component and subassembly manufacturing 106 and system integration 108 in FIG. 1, for example, without limitation, by substantially expediting the assembly of or reducing the cost of aircraft 200. Similarly, one or more of apparatus embodiments, method embodiments, or a combination thereof may be utilized while aircraft 200 is in service 112 or during maintenance and service 114 in FIG. 1.

For example, without limitation, advantageous embodiments may be used for drawing composite parts together during component and subassembly manufacturing, system integration, and/or maintenance and service 114. The different advantageous embodiments may be used to join these composite parts for use within interior 206 of aircraft 200 in these illustrative examples.

The different advantageous embodiments recognize and take into account that the currently used processes for joining composite parts to each other may be time consuming and costly. The different advantageous embodiments recognize and take into account that the currently used processes may also result in higher than desired out of tolerance joints of the joined parts.

Thus, the different advantageous embodiments provide a method and apparatus for joining composite parts to each other. A first composite part may be aligned with a second composite part to form an aligned structure with a splice line. An adhesive layer may be placed on the splice line to cover the splice line. A composite material may be placed on the adhesive layer. The aligned structure may be cured with the adhesive layer and the composite material to form a joined structure.

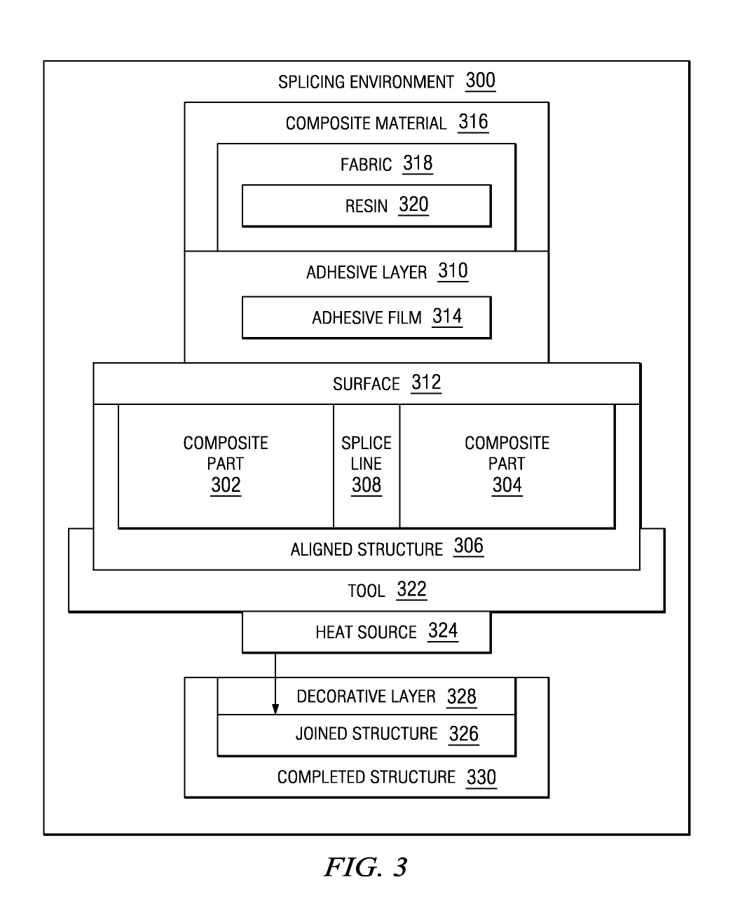

With reference now to FIG. 3, a diagram of a splicing environment is depicted in accordance with an advantageous embodiment. Splicing environment 300 may be used to join composite part 302 to composite part 304. Composite part 302 may be aligned with composite part 304 to form aligned structure 306 with splice line 308. Aligned structure 306 may be an aircraft structure for use within interior 206 of aircraft 200 in these illustrative examples.

In this depicted example, adhesive layer 310 may be placed onto surface 312 of aligned structure 306 such that adhesive layer 310 covers splice line 308. Adhesive layer 310 may be, for example, without limitation, adhesive film 314. Adhesive film 314 may be, for example, without limitation, an epoxy film or some other suitable type of adhesive film.

Composite material 316 may be placed onto adhesive film 314. Composite material 316 may be fabric 318 impregnated with resin 320. In the different advantageous embodiments, fabric 318 may be, for example, without limitation, a fiberglass fabric, a carbon fabric, and/or some other suitable fabric. Resin 320 may be, for example, without limitation, a phenolic resin, an epoxy resin, or some other suitable resin.

In the different advantageous embodiments, tool 322 may secure aligned structure 306, adhesive layer 310, and composite material 316 in place. Tool 322 may be, for example, without limitation, a die that may cover or secure only a portion of aligned structure 306 on which adhesive layer 310 and composite material 316 may be located. Tool 322 may be, for example, without limitation, a contoured aluminum die, a caul plate, or some other suitable tool. Tool 322 may receive and/or hold aligned structure 306 in place during a curing process. Tool 322 also may provide pressure by clamping aligned structure 306 before and/or during the curing process.

Aligned structure 306 with adhesive layer 310 and composite material 316 may be placed on tool 322 and cured using heat source 324. Heat source 324 may be implemented using a number of different types of devices. For example, without limitation, heat source 324 may be heating elements attached to and/or embedded in tool 322. In other advantageous embodiments, tool 322 may be placed into heat source 324 when heat source 324 takes the form of an autoclave oven. Of course, heat source 324 may take other forms and may heat tool 322 and aligned structure 306 in a number of different ways including, for example, without limitation, heated oil, steam, electricity, and other suitable heating mechanisms. Additionally, heat source 324 also may apply pressure during the curing process.

With the use of adhesive layer 310 and composite material 316, curing aligned structure 306 with adhesive layer 310 and composite material 316 may only require around eight minutes instead of the currently used 24 hours with current processes to splice parts to each other.

After aligned structure 306 has been cured with adhesive layer 310 and composite material 316, aligned structure 306 may become joined structure 326. Decorative layer 328 may be bonded onto joined structure 326 to form completed structure 330.

The illustration of splicing environment 300 in FIG. 3 is not meant to imply architectural or physical limitations to the manner in which different advantageous embodiments may be implemented. Some advantageous embodiments may have other components in addition to, or in place of, the ones illustrated. In other advantageous embodiments, some components may be unnecessary. For example, without limitation, additional composite parts, in addition to composite parts 302 and 304, may be spliced together to form joined structure 326. In these examples, composite part 302 and composite part 304 may be similar structures such as, for example, without limitation, light shields. In yet other advantageous embodiments, composite part 302 and composite part 304 may be dissimilar structures joined to each other using adhesive layer 310 and composite material 316.

In another illustrative example, splicing environment 300 may employ another heat source other than heat source 324. For example, a heat blanket and/or inductive heating also may be used, depending on the particular implementation.

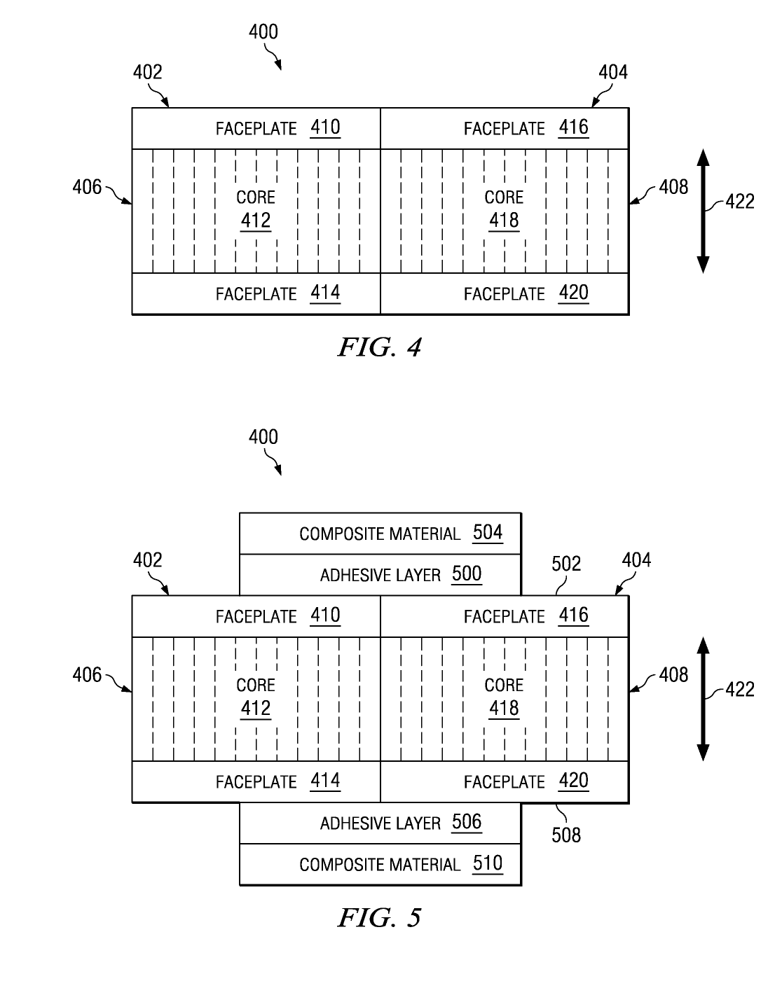

With reference now to FIG. 4, a diagram of a cross-sectional view of an aligned structure is depicted in accordance with an advantageous embodiment. In this example, aligned structure 400 may include composite part 402 and composite part 404. Composite part 402 may be honeycomb sandwich 406, while composite part 404 may be honeycomb sandwich 408.

Honeycomb sandwich 406 may comprise faceplate 410, core 412, and faceplate 414. Honeycomb sandwich 408 may comprise faceplate 416, core 418, and faceplate 420. Faceplate 410, faceplate 414, faceplate 416, and faceplate 420 may be composite materials in the form of laminates.

Core 412 and core 418 may be honeycomb cores with cells aligned in the direction of arrow 422. Aligned structure 400 may take various forms. For example, without limitation, aligned structure 400 may be a light shield, a wall panel, a composite panel, a divider panel, a floor panel, or some other suitable structure. A light shield may be a cover that may be placed over a light source. The light shield may diffuse light from a light source and/or provide a protective barrier.

With reference now to FIG. 5, a diagram of a cross-sectional view illustrating layers of materials for joining composite parts is depicted in accordance with an advantageous embodiment. In this example, adhesive layer 500 may be placed on surface 502 of aligned structure 400. Composite material 504 may be placed onto adhesive layer 500. In a similar fashion, adhesive layer 506 may be placed on surface 508 of aligned structure 400. Composite material 510 may be placed onto adhesive layer 506. Of course, in some advantageous embodiments, adhesive layer 506 and composite material 510 may be unnecessary, depending on the particular implementation.

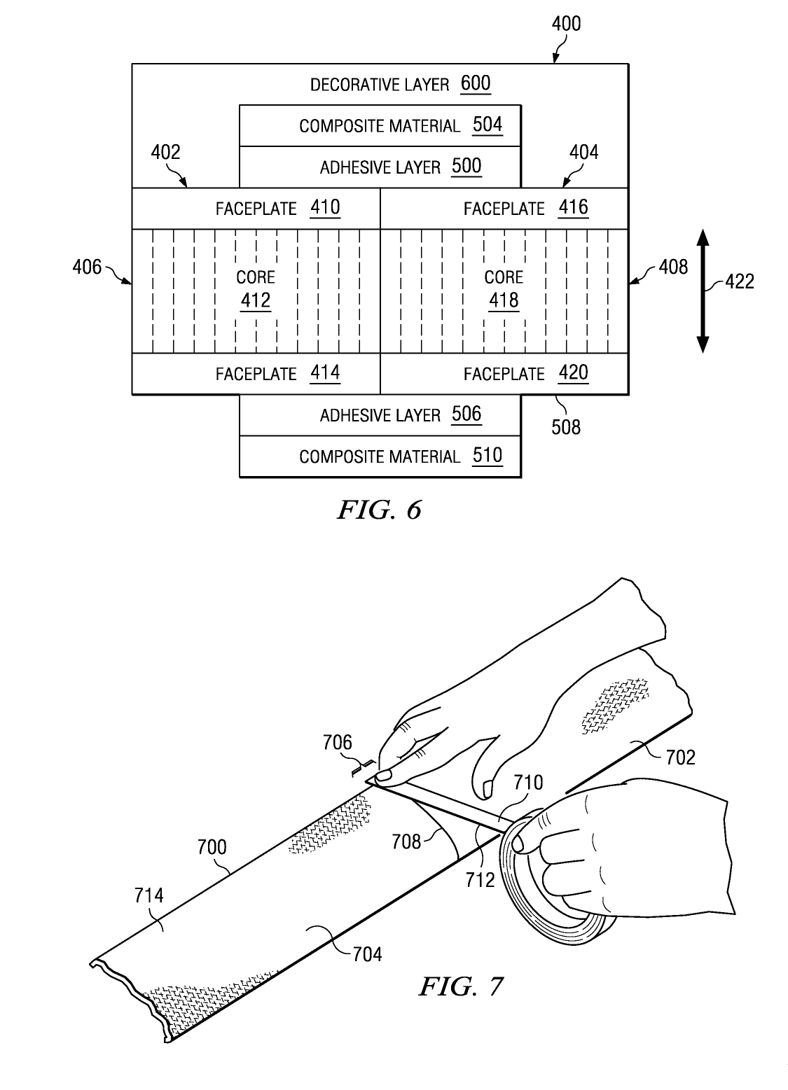

With reference now to FIG. 6, a diagram of a cross-sectional view illustrating a completed structure is depicted in accordance with an advantageous embodiment. In FIG. 6, decorative layer 600 may be applied to aligned structure 400 after adhesive layer 500, composite material 504, adhesive layer 506, and composite material 510 have been cured.

With reference now to FIGS. 7-11, diagrams illustrating joining composite parts to each other are depicted in accordance with an advantageous embodiment. With reference first to FIG. 7, composite honeycomb panel 700 and composite honeycomb panel 702 may be aligned with each other to form aligned structure 704. This alignment may form splice area 706 with splice line 708.

In this illustration, adhesive layer 710 may take the form of epoxy film 712. Epoxy film 712 may be placed onto top side 714 of aligned structure 704 in splice area 706 to cover splice line 708.

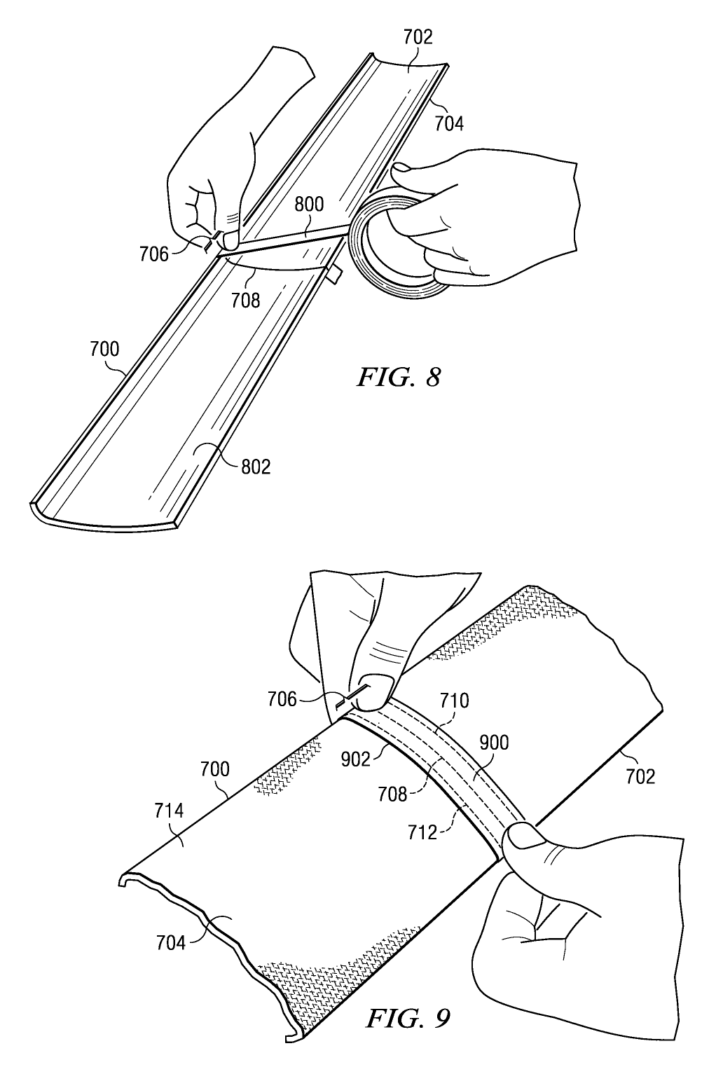

Turning next to FIG. 8, a diagram illustrating application of an adhesive layer is depicted in accordance with an advantageous embodiment. In this example, epoxy film 800 may be applied to bottom side 802 of aligned structure 704 over splice line 708 in splice area 706.

With reference now to FIG. 9, a diagram illustrating an application of a composite material to a structure is depicted in accordance with an advantageous embodiment. In this operation, composite material 900 may take the form of reinforced prepreg 902. Reinforced prepreg 902 may be placed onto epoxy film 712 on top side 714 of aligned structure 704.

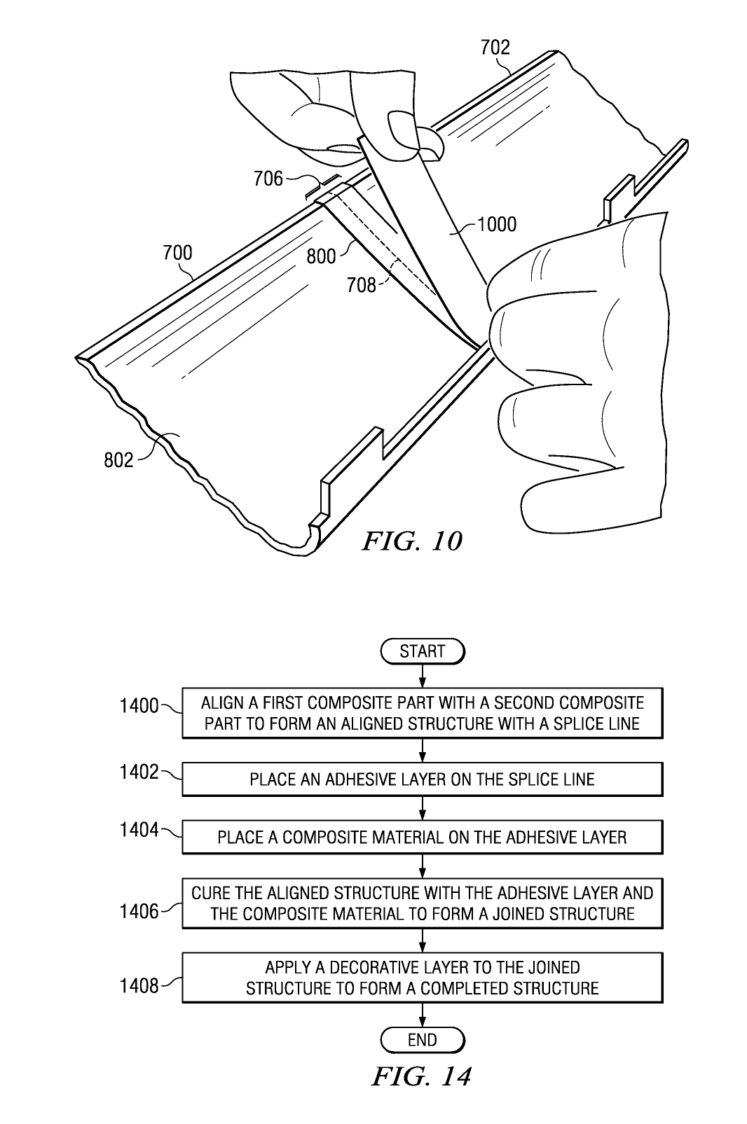

With reference now to FIG. 10, a diagram illustrating application of a composite material to a structure is depicted in accordance with an advantageous embodiment. In this illustration, reinforced prepreg 1000 may be applied to bottom side 802 of aligned structure 704 over splice line 708 in splice area 706.

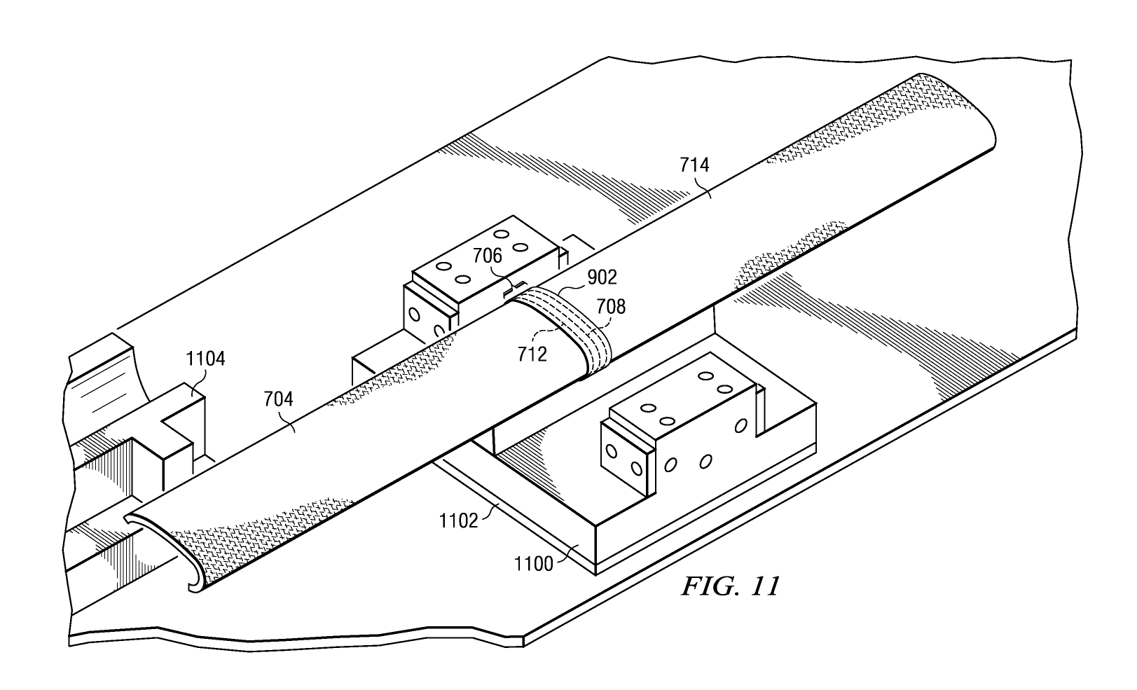

In FIG. 11, a diagram illustrating an aligned structure on a tool is depicted in accordance with an advantageous embodiment. In this illustrative example, aligned structure 704 with epoxy film 712, epoxy film 800 (not shown), reinforced prepreg 902, and reinforced prepreg 1000 (not shown) on splice line 708 in splice area 706 is illustrated on match mold die 1100. Match mold die 1100 is an example of one implementation of tool 322 in FIG. 3.

Match mold die 1100 includes part 1102 and part 1104. Match mold die 1100 may be designed to fit over a portion of aligned structure 704. Match mold die 1100 may cover splice line 708 and splice area 706. Match mold die 1100 may be heated to apply heat to splice area 706. Match mold die 1100 also may apply pressure to splice area 706.

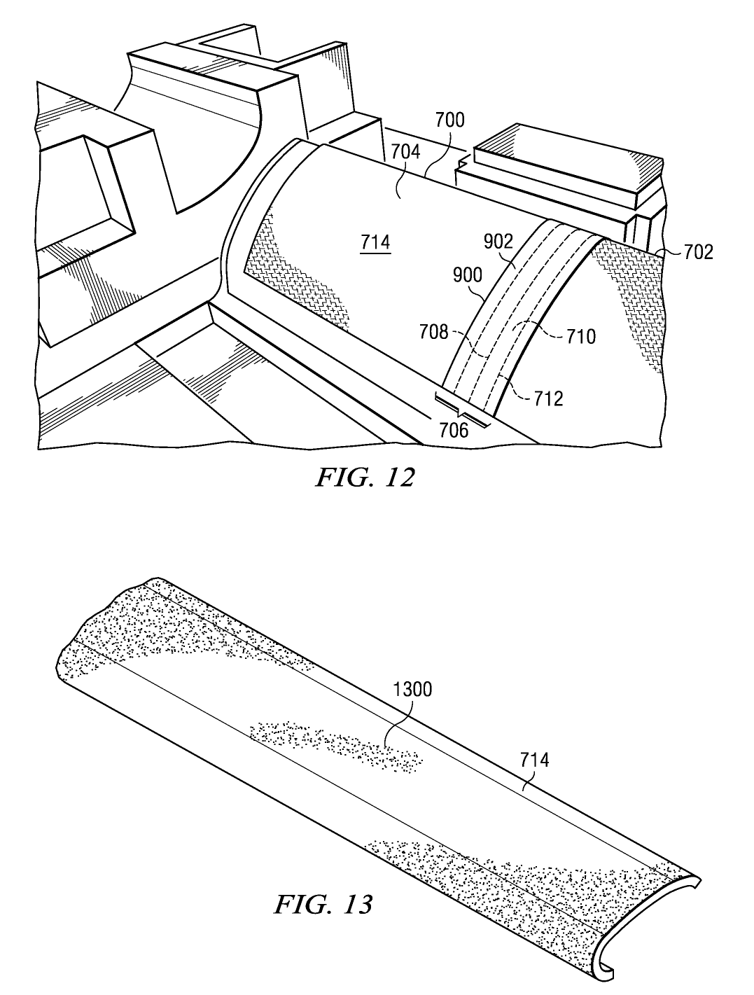

Turning to FIG. 12, a diagram illustrating a cured aligned structure is depicted in accordance with an advantageous embodiment. In this example, aligned structure 704 with epoxy film 712 and reinforced prepreg 902 on top side 714 may have been cured to join composite honeycomb panel 700 to composite honeycomb panel 702. With reference to FIG. 13, aligned structure 704 may be seen with decorative layer 1300 applied to top side 714.

The different features and/or operations illustrated in FIGS. 7-13 are not meant to imply limitations to the manner in which composite components may be joined to each other. For example, in other advantageous embodiments, other types of composite components other than honeycomb panels may be joined to each other. In yet other advantageous embodiments, layers of materials rather than film adhesives or tape may be used to apply the different materials to splice area 706.

With reference now to FIG. 14, a flowchart of a process for joining composite parts is depicted in accordance with an advantageous embodiment. The process illustrated in FIG. 14 may be implemented in a splicing environment such as, for example, splicing environment 300 in FIG. 3.

The process may begin by aligning a first composite part with a second composite part to form an aligned structure with a splice line (operation 1400). The process may then place an adhesive layer on the splice line (operation 1402). This adhesive layer may be, for example, without limitation, an epoxy film. The process may place a composite material on the adhesive layer (operation 1404). The composite material may be, for example, without limitation, a reinforced prepreg.

The aligned structure with the adhesive layer and the composite material may be cured to form a joined structure (operation 1406). A decorative layer may then be applied to the joined structure to form a completed structure (operation 1408), with the process terminating thereafter.

The illustration of operations in FIG. 14 is not meant to limit the manner in which different advantageous embodiments may be implemented. In other advantageous embodiments, other operations in addition to, or in place of, the ones illustrated may be used. Further, in some advantageous embodiments, some operations may be unnecessary. For example, the placing of the adhesive layer and the composite material may be on both sides of an aligned structure in some advantageous embodiments. In still other advantageous embodiments, the aligned structure with the adhesive layer and the composite material may be placed into a die prior to the curing operation.

Thus, the different advantageous embodiments provide a method and apparatus for joining composite parts to each other. The different advantageous embodiments may provide a quicker process for joining composite parts. Further, the different advantageous embodiments also may provide for better joining or splicing of parts and/or less out of tolerance occurrences as compared to currently used processes.

The description of the different advantageous embodiments has been presented for purposes of illustration and description, and it is not intended to be exhaustive or limited to the embodiments in the form disclosed. Many modifications and variations will be apparent to those of ordinary skill in the art. Further, different advantageous embodiments may provide different advantages as compared to other advantageous embodiments.

Although the different advantageous embodiments have been described with respect to aircraft, other advantageous embodiments may be applied to other types of objects. For example, without limitation, other advantageous embodiments may be applied to a mobile platform, a stationary platform, a land-based structure, an aquatic-based structure, a space-based structure, and/or some other suitable object.

More specifically, the different advantageous embodiments may be applied to, for example, without limitation, a submarine, a bus, a personnel carrier, a tank, a train, an automobile, a spacecraft, a space station, a satellite, a surface ship, a power plant, a dam, a manufacturing facility, a building, and/or some other suitable object.

The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for joining composite parts, the method comprising:
aligning a first composite part with a second composite part to form an aligned structure with a splice line;
placing an adhesive layer on the splice line;
placing a composite material on the adhesive layer;
curing the aligned structure with the adhesive layer and the composite material to form a joined structure.

2. The method of claim 1, wherein the curing step comprises:
placing the aligned structure with the adhesive layer and the composite material in a die; and
heating the aligned structure in the die.

3. The method of claim 2, wherein the heating step comprises:
heating the aligned structure in the die with the aligned structure under pressure.

4. The method of claim 1 further comprising:
applying a decorative layer to the joined structure.

5. The method of claim 1, wherein the aligned structure has as a first side and a second side, wherein the adhesive layer and the composite material are placed on the first side and the second side, and wherein the adhesive layer and the composite material are placed on the second side.

6. The method of claim 2, wherein the die covers the splice line after the adhesive layer and the composite material have been placed on the splice line.

7. The method of claim 1, wherein the adhesive layer is selected from one of an adhesive film and an epoxy film.

8. The method of claim 1, wherein the aligned structure is an aircraft structure.

9. The method of claim 1, wherein the composite material is a fabric with an impregnated resin.

10. The method of claim 9, wherein the fabric is selected from one of a fiberglass fabric and a carbon fabric.

11. The method of claim 9, wherein the resin is selected from one of a phenolic resin and an epoxy resin.

12. The method of claim 1, wherein the joined structure is selected from one of a composite panel, a wall panel, divider panel, a floor panel, and a light shield.

13. The method of claim 1, wherein the first composite part is a first honeycomb sandwich panel and the second part is a second honeycomb sandwich panel.

14. A method for manufacturing a composite honeycomb sandwich panel, the method comprising:
aligning a first composite honeycomb sandwich panel with a second composite honeycomb sandwich panel to form an aligned structure with a splice line;
placing an epoxy film on the splice line, wherein the epoxy film covers the splice line;
placing a fabric with an embedded resin on the epoxy film, wherein the aligned structure has a first side and a second side, wherein the epoxy film and the fabric with the embedded resin are placed on the first side and the second side, wherein the fabric is selected from one of a fiberglass fabric and a carbon fabric, and wherein the resin is selected from one of a phenolic resin and an epoxy resin;
placing the aligned structure with the epoxy film and the fabric with the embedded resin in a die, wherein the die covers the splice line;
heating the aligned structure in the die under pressure to form a joined structure; and
applying a decorative layer on the joined structure, wherein the completed structure is selected from one of a composite panel, a wall panel, and a light shield.

15. An apparatus comprising:
a first composite part aligned with a second composite part to form an aligned structure with a splice line;
an adhesive layer covering the splice line;
a composite material located on the adhesive layer;
a tool capable of holding the aligned structure with the adhesive layer covering the splice line and the composite material located on the adhesive layer.

16. The apparatus of claim 15, wherein the adhesive layer is selected from one of an adhesive film and an epoxy film.

17. The apparatus of claim 17, wherein the aligned structure is an aircraft part.

18. The apparatus of claim 15, wherein the composite material is a fabric with an impregnated resin.

19. The apparatus of claim 18, wherein the fabric is selected from one of a fiberglass fabric and a carbon fabric.

20. The apparatus of claim 18, wherein the resin is selected from one of a phenolic resin and an epoxy resin.

21. The apparatus of claim 15, wherein the joined structure is selected from one of a composite panel, a wall panel, divider panel, a floor panel, and a light shield.

22. The apparatus of claim 15, wherein the first composite part is a first honeycomb sandwich panel, and the second composite part is a second honeycomb sandwich panel.

23. An apparatus for splicing honeycomb composite parts, the apparatus comprising:
a first composite honeycomb sandwich panel aligned with a second composite honeycomb sandwich panel to form an aligned structure with a splice line;
an epoxy film located on the splice line;
a fabric with an embedded resin located on the epoxy film;
a tool capable of holding the aligned structure with the epoxy film located on the splice line and the fabric with the embedded resin, wherein the tool is a match mold die capable of receiving the aligned structure and capable generating pressure on the aligned structure.
